(19) United States
(12) Patent Application Publication
(10) Pub. No.: US 2024/0254717 A1
(43) Pub. Date: Aug. 1, 2024

(54) METHOD FOR THE IMPERMEABILIZATION OF SOILS

(71) Applicant: THESS PTY LTD, Bundall (AU)

(72) Inventors: Paul Lyden, Burleigh Heads (AU); Dirk Geraedts, Downtown Dubai (AE)

(73) Assignee: THESS PTY LTD, Bundall (AU)

(21) Appl. No.: 18/561,214

(22) PCT Filed: May 18, 2021
(86) PCT No.: PCT/AU2021/050463

§ 371 Date: Nov. 15, 2023

(51) Int. Cl. E02D 31/00; C08L 75/04

(52) U.S. Cl. CPC E02D 31/002; C08L 75/04

(57) ABSTRACT

The present invention provides a method of making soil substantially impermeable to a chemical compound or composition that may pollute groundwater, comprising applying a polyurethane resin to the soil, wherein said polyurethane resin is adapted to incorporate soil particles into a matrix as it penetrates the soil to make the soil substantially impermeable to said chemical compound or composition. It also relates to a method of containing a chemical compound or composition that may pollute groundwater within a containment structure that has a base formed from soil, a method of forming or repairing such a structure and to containment structures that surround a storage facility for storing a chemical compound or composition.

### TECHNICAL FIELD

The invention relates to polyurethane-based resins and their application in making soil substantially impermeable, for example, to prevent outflow of a liquid from a containment structure with a base formed from soil, such as a tank farm.

### BACKGROUND

Fuel tanks can be found all over the world. They are used to store and buffer all types of fuels before use or before transport. Though tanks are well designed and built, there is always a risk of the tanks leaking or accidental spills during transfer. To avoid pollution of the soil and—eventually—the ground water below the tank farms, tanking of these farms is necessary. Different authorities all over the world have set standards for tanking fuel storage facilities.

Tanking systems include membranes buried under the soil, membranes on top of the soil and concreting the surfaces between tanks. Solid sheet membranes have to be welded or glued together to form a continuous impermeable layer. Membrane-forming material such as polymethylmethacrylate (PMMA) may be sprayed as a liquid over the soil—either directly onto the soil or onto a geotextile material laid over the soil—but material applied in different spray sessions still needs to fuse to form a continuous membrane or layer. Such a membrane is often covered with soil or concrete tiles as otherwise it is prone to damage and is not suitable for traffic.

### SUMMARY OF THE INVENTION

In one aspect the present invention relates to a method of making soil substantially impermeable to a chemical compound or composition that may pollute groundwater, comprising applying a polyurethane resin to the soil, wherein said polyurethane resin is adapted to incorporate soil particles into a matrix as it penetrates the soil to make the soil substantially impermeable to said chemical compound or composition.

In another aspect the present invention relates to a method of containing a chemical compound or composition that may pollute groundwater within a containment structure that has a base formed from soil, comprising applying a polyurethane resin to the soil, wherein said polyurethane resin is adapted to incorporate soil particles into a matrix as it penetrates the soil to make the soil substantially impermeable to said chemical compound or composition.

In a further aspect the present invention relates to a method of forming or repairing a containment structure for containing a chemical compound or composition that may pollute groundwater, comprising the steps of:
a) constructing a containment structure with a base formed from soil;
b) applying a polyurethane resin to the soil, wherein said polyurethane resin is adapted to incorporate soil particles into a matrix as it penetrates the soil to make the soil substantially impermeable to said chemical compound or composition.

In a still further aspect, the present invention relates to a containment structure for containing a chemical compound or composition that may pollute groundwater, wherein the base of the containment structure is formed from soil and includes a layer comprising a matrix of polyurethane resin and soil particles that makes the soil substantially impermeable to said chemical compound or composition.

Further features of the present invention will become apparent from the following detailed description.

Throughout this specification, unless the context requires otherwise, the words “comprise”, “comprises” and “comprising” will be understood to imply the inclusion of a stated integer or group of integers but not the exclusion of any other integer or group of integers.

### BRIEF DESCRIPTION OF DRAWINGS

In order that the invention may be readily understood and put into practical effect, preferred embodiments will now be described by way of example with reference to the accompanying figures wherein:

FIG. 1 illustrates the pores of a soil substrate filled to varying degrees with a polyurethane composition;

FIG. 2 illustrates the pores of a vertical cross section of soil substrate (sand substrate), as they are gradually filled by first and second sequential applications of the polyurethane composition;

FIG. 3 provides an exemplary application pattern for the first layer of polyurethane composition for a single zone;

FIG. 4 provides an exemplary application pattern for the first layer of polyurethane composition for two zones;

FIG. 5 provides an exemplary application pattern for a second or subsequent layer being applied a large zone (up to 2000 m2) comprising several of the zones used for application of the first layer;

FIG. 6 provides an exemplary application pattern for the application of 3 sublayers to form a first layer of polyurethane composition on a sloped area;

FIG. 7 provides an illustration of the application of the polyurethane composition to an area surrounding a pipe protrusion; and

FIG. 8 provides an example of the shaping of the soil substrate, and the application of the polyurethane composition to an area where the soil substrate touches the base of a tank or other object.

### DETAILED DESCRIPTION OF THE INVENTION

The present invention relates to the application of a polyurethane resin to soil to make the soil substantially impermeable to chemical compounds or compositions that may pollute groundwater. This has particular application to preventing penetration of spills into the soil in the vicinity of containment structures for the storage of chemical compounds or compositions that may pollute groundwater, such as hydrocarbons or hydrocarbon-based compositions. In particular, the present invention relates to tank farms used to store hydrocarbon fuels like diesel, M91 fuel, M95 fuel, M98 fuel, kerosene and crude oil.

In an embodiment the polyurethane resin creates a substantially impermeable layer in the soil. While not wishing to be bound by theory, it is believed that the substantially impermeable layer is created when the voids between particles of soil are filled with resin. The substantially impermeable layer generally forms in the top layer of the soil, making it substantially impermeable to hydrocarbons. The top layer of the soil becomes part of the tanking system, incorporating the soil particles into a structural matrix of a polyurethane polymer. Creation of a tanking system allows a clean-up of the spill to be executed without penetration of the spilled substance through the soil into ground water.

As used herein, the term “substantially impermeable” will be understood to mean that the chemical compound or composition that may pollute groundwater cannot sink deeper into the soil than 120 mm in a period of 7 days.

In an embodiment the soil is made impermeable to said chemical compound or composition such that the chemical compound or composition that may pollute groundwater does not penetrate into the soil in a period of 7 days.

In an embodiment the polyurethane resin serves to harden and strengthen the soil.

In an embodiment the substantially impermeable layer is sufficiently thick to block transfer of hydrocarbons through the layer. It will be appreciated that the cost of applying a layer which is thicker than required is a practical limitation to the upper limit for the thickness the layer, while a layer which is too thin might not block passage of hydrocarbon to a sufficient degree.

In an embodiment the substantially impermeable layer is from up to about 2 to 12 cm deep.

In an embodiment the substantially impermeable layer is from up to about 3 to 10 cm deep.

In an embodiment the substantially impermeable layer is from up to about 4 to 7 cm deep.

In an embodiment the polyurethane has low viscosity to allow it to penetrate the soil. Typically, the viscosity of the polyurethane prepolymer is less than about 80 centipoise at 21° C. In an embodiment the viscosity is from 40 to 80 cps at 21° C., typically from 50 to 60 cps at 21° C. The person skilled in the art will understand that the polyurethane should be more viscous for soil types with a coarse grain, such as gravel soil, so it does not filter right through the soil and not create the barrier required. The person skilled in the art will understand that the polyurethane should be less viscous for soil types with a fine grain, such as sandy soils. A polyurethane can be made more liquid by heating up the product, and more viscous by adding a thixotropic agent if desired.

In an embodiment cross-linking of polyurethane prepolymers occurs subsequently to the application of the polyurethane resin to the soil. While not wishing to be bound by a theory, it is believed that application of a relatively low viscosity polyurethane prepolymer allows penetration of the prepolymer into the soil to a desired extent and the increase in molecular weight that occurs as the polymer forms arrests penetration and facilitates binding to soil particles.

In an embodiment, the polyurethane resin is a water activated polyurethane resin.

The person skilled in the art will understand that polyurethanes are the reaction product of a diol or polyol and a polyisocyanate. The degree of hydrophilicity is a function of the type and proportion of polar groups in the backbone of the polymer, which groups are controlled by appropriate selection of the reactive hydrogen terminated resins or compounds used in the polymer synthesis.

In an embodiment the polyurethane is a hydrophobic polyurethane.

In an embodiment the polyurethane is a hybrid resin containing a mix of hydrophilic and hydrophobic residues.

Examples of the specific polyols which may be used in the synthesis of a polyurethane prepolymer include dipropylene glycol, polypropylene glycol (PPG), polyethylene glycol, polybutadiene glycol, polyethylene triol, and polypropylene triol, and reaction products thereof such as those produced by the catalysed addition of monomers of propylene oxide (PO) and/or ethylene oxide (EO) to an initiator and a starter. Typical starters are glycerine, mono-propylene glycol, sucrose, sorbitol, water or amines. An example of such a product is a glycerolpropoxylate-block-ethoxylate. The nature and range of polyols that may be used in the preparation of polyurethanes will be well understood by the person skilled in the art. Examples of the specific isocyanates which may be used in the synthesis of a polyurethane prepolymer include 4,4′-methylenebis(phenyl isocyanate); diphenylmethane diisocyanate (MDI); polymethylene polyphenylisocyanate (polymeric MDI); o-(p-isocyanatobenzyl)phenyl isocyanate; 2,4 toluene diisocyanate (TDI); 2,6 TDI; hexamethylene diisocyanate and isophorone diisocyanate.

Polyurethanes can also be supplied as single-component systems, made up of a partially reacted polyurethane polymer, referred to as prepolymer. During fabrication, these systems further react with moisture to form a cured solid. In a single component polyurethane polymerisation commences when the resin comes into contact with water. In an embodiment, the reaction commences when the polyurethane prepolymer is applied to soil. Water may have been applied to the soil before application of the polyurethane to wet the soil, or the reaction may be with water contained in the soil.

Polyurethanes may also be supplied as a two-component system comprising the isocyanate and the polyol. In a two-component polyurethane, the reaction commences when the polyol and polisocyanate are brought into contact (with or without a catalyst).

In an embodiment, the polyurethane resin is a single-component water-activated polyurethane resin.

In an embodiment, catalysts for catalysing the reaction of the isocyanate with water groups are introduced to the polyurethane resin. In an embodiment the catalyst is introduced just prior to application of the polyurethane resin to the soil.

Using a catalyst increases the rate at which the resin sets. The amount of catalyst can be adjusted to alter this rate. In an embodiment, the amount of catalyst is optimized to prevent or reduce the formation of holes in the substantially impermeable layer. In an embodiment, no catalyst is present in the polyurethane resin. In an embodiment, the polyurethane resin is applied to the soil in the absence of a catalyst.

In an embodiment, catalysts are selected from the group consisting of catalysts based on tin carboxylates, amines, bismuth carboxylates, zinc carboxylates, zirconium carboxylates, and nickel carboxylates, typically an amine catalyst, more particularly a tertiary amine catalyst such as 2,2-dimorpholinyl-diethylether.

In an embodiment, no catalyst is used. In this embodiment the reaction is slower which can produce a more uniform product without imperfections such “pinholes” in the cured resin.

In an embodiment, the polyurethane resin is formulated such that it can react with a soil substrate and water to set and form a substantially impermeable barrier. In an embodiment, the barrier remains substantially impermeable to chemical compounds or compositions that may pollute groundwater for a period of at least 7 days. In an embodiment, the barrier remains substantially impermeable to chemical compounds or compositions that may pollute groundwater for a period of at least 14 days.

In an embodiment, the polyurethane resin has a low viscosity to allow easy penetration into a soil.

The time taken for the polymerisation reaction is a function of temperature and catalyst concentration. In an embodiment, the polyurethane resin has a reaction time of between 15 minutes and 24 hours. In an embodiment, the polyurethane resin has a reaction time of between 2 hours and 12 hours.

In an embodiment the polyurethane resin is formulated as a composition that further comprises a carrier. In an embodiment the carrier is a plasticizer. A person skilled in the art will recognize that the plasticizer reduces the viscosity of the polyurethane resin. In an embodiment the carrier is a polar solvent such as an ester or ketone. In an embodiment the carrier is a dibasic ester mixture (a mixture of different methyl dibasic esters such as dimethyl glutarate, dimethyl succinate and dimethyl adipate).

In an embodiment the polyurethane is sprayed or poured onto the soil. Typically, the polyurethane is applied in multiple coats to progressively build the substantially impermeable layer. This may be contrasted with conventional application of polyurethane as a sealant to keep water from flowing into a structure such as a basement, where the compound is injected so as to form a monolithic mass in a cavity or space.

The person skilled in the art will appreciate that, aside from preventing passage of hydrocarbons, the substantially impermeable layer may be substantially impermeable to other liquids such as water.

There are a variety of soil classifications, as will be well understood by the person skilled in the art.

Soils may be classified according to their particle size. Terms such as gravel size, sand size, silt size, and clay size are used to indicate particle sizes. These terms are used as a designation of particles size only, and do not signify the naturally occurring soil types, which are mixtures of particles of different sizes and exhibit definite characteristics.

There are a variety of systems used to classify soil according to their particle size. For example, the International Soil Classification System classifies soils as follows:

| | | | | | | | | |
|---|---|---|---|---|---|---|---|---|
| 0.002 mm | 0.75 | 0.425 | 2.00 | 4.75 | 20 | 80 | 300 mm | |
| Clay | Silt | Fine | Medium | Coarse | Fine | Coarse | Cobble | Boulder |

| | | | |
|---|---|---|---|
| (Size) | (size) | Sand | Gravel |

In an embodiment the soil includes sand size particles.

In an embodiment the soil includes particles with a particle size in the range of 0.075 mm to 4.5 mm.

However, soils occurring in nature are composed of a different percentage of sand, silt, and clay size particles. Soil classification of composite soils based on the particle size distribution are known as textural classification. An example of these textural classifications is the triangular diagram produced by the U.S. Public Roads Administration which allows the classification of a soil into types such as sandy, sandy loam, sandy clay and so on, based on the percentages of sand, silt and clay size particles making up the soil.

The person skilled in the art will appreciate that little or nothing penetrates pure clay, not even fuels, and therefore there is limited necessity for the invention where the soil is a pure clay soil. The invention has most application to sandy soils as they have great porosity and spills will penetrate to the groundwater rapidly. The invention has applicability to silty soils, sandy soils with clay and so on to a greater or lesser extent. Where soils that contain a mixture of particle sizes are encountered, the person skilled in the art will appreciate that the amount of resin per square metre and the application technique may have to be adjusted.

In an embodiment the soil is selected from the group consisting of a sandy soil, loamy sand, sandy loam, loam, sandy clay loam, sandy clay, silty loam and silty clay loam according to the U.S. Bureau of Public Roads classification. In an embodiment the soil is a sandy soil.

The person skilled in the art will appreciate that, while clay soils are not highly permeable, clays can dry out and crack, if this occurs in the base of a tank farm and a pollutant such as fuel escapes, the fuel sinks in the soil even more easily than for a permeable soil and is more difficult to recuperate. Accordingly, in an embodiment a layer of permeable soil is placed on top of the clay soil and that layer of permeable soil is treated in accordance with the present invention. In particular, a layer of sand is laid on top of the clay soil. Typically, the sand layer is 5 to 20 centimetres thick, preferably around 10 centimetres thick.

In an embodiment, the polyurethane resin is applied to the top or surface layer of the soil. In an embodiment, the polyurethane resin penetrates the top or surface layer of the soil up to a depth about 4 to 7 cm deep (actual depth depending on the requirements for the project). In an embodiment, the polyurethane resin penetrates the soil and coats particles of the substrate with a layer of polyurethane, and the coated particles stick to each other and set to form part of a structural matrix with the polyurethane polymer.

In an embodiment the polyurethane resin sinks into the soil and coats particles of the substrate with a layer of polyurethane and the coated particles stick to each other to form part of a structural matrix with the polyurethane polymer. After application, the top layer of the soil becomes part of a tanking system, incorporating the sand particles into a structural matrix of polyurethane polymer. The tanking system will also include structures such as walls to contain a leak or spill and retain it. In an embodiment, the structures contain the leak or spill for at least 7 days. In an embodiment, the structures contain the leak or spill for at least 14 days. This allows spills to be cleaned up during that period.

In an embodiment the structural matrix formed is substantially impermeable to hydrocarbons after fully curing. In an embodiment, the structural matrix is fully cured after about 7 days. In an embodiment, the structural matrix formed hardens and strengthens the soil. In an embodiment, substantial impermeability to hydrocarbons is achieved by all pores in a specific layer being filled with the resin such that no liquid can pass though the layer. In an embodiment the structural matrix remains substantially impermeable to chemical compositions or compounds that may pollute groundwater for a period of at least 14 days.

In an embodiment the substantially impermeable layer forms the base of a containment structure. In particular, the substantially impermeable layer forms the base of a tanking farm. The tanking farm, typically, has a base formed from the soil present at the site, and walls surrounding the area to contain any spillage from the tanks in the tank farm. In an embodiment, the walls are made from soil and are also treated in accordance with the present invention.

In an embodiment, the surface of the soil is substantially planar. In an embodiment, the surface of the soil is sloped. In an embodiment, the surface of the soil is curved.

In an embodiment, the soil is of normal permeability. In other words, liquid penetrates the soil at a typical rate. In an embodiment, the soil is of low permeability. In other words, liquid penetrates the soil at a slower than typical rate. In an embodiment, the soil is of high permeability. In other words, liquid penetrates the soil at a faster than typical rate. As will be well understood by the person skilled in the art, the permeability of a soil is dependent on the sieve curve of the soil i.e. the mix of large, medium, small and fine sand granulates in the soil.

In an embodiment, the method further comprises, prior to application of the polyurethane resin, shaping the surface or top layer of the soil to the desired shape and flatness. In an embodiment, the method further comprises, prior to application of the polyurethane resin, shaping the surface or top layer of the soil to be even and flat, in order to prevent the formation of puddles of the resin. In an embodiment, the method further comprises, prior to application of the polyurethane resin, removing debris and large rocks from the soil surface. In an embodiment, the method further comprises, prior to application of the polyurethane resin, compacting the top of the soil. In an embodiment, the top of the soil is compacted by rolling over it.

In an embodiment, the method further comprises compacting the surface by rolling a cylinder over it. In an embodiment, the cylinder weighs between 20 and 50 kg per meter of cylinder roll.

In an embodiment, the method further comprises, between around 5-50 minutes prior to application of the polyurethane resin, spraying a mist of water over the soil surface. In an embodiment, the mist of water is applied around 10 minutes prior to application of the polyurethane resin. In an embodiment, the mist of water is applied around 30 minutes prior to application of the polyurethane resin. In an embodiment, the polyurethane resin should be applied before the water fully evaporates. The person skilled in the art will appreciate that this time period may need to be adjusted depending on weather conditions and/or the moisture levels of the soil substrate. The person skilled in the art will also appreciate that the mist of water does not need to be applied if the soil has sufficient moisture levels.

In an embodiment, the soil surface contains interruptions such as pipe penetrations and tank-soil interfaces. In an embodiment, the method further comprises, prior to application of the polyurethane resin, shaping the areas around interruptions in the soil surface (such as pipe penetrations and tanks) to the required form. Areas where the substantially impermeable layer needs to be broken up, such when installing or repairing equipment, piping, and infrastructure, can be repaired and replaced easily.

In an embodiment, the method comprises spraying the polyurethane resin onto the soil. In an embodiment, the method comprises pouring the polyurethane resin onto the soil. In an embodiment of invention, the method comprises coating the soil with the polyurethane resin. In an embodiment of invention, the method comprises saturating the soil with the polyurethane resin.

In an embodiment a first aliquot of the polyurethane resin is poured onto the soil in a first step and a second aliquot of the polyurethane resin is sprayed onto the soil in a second step.

In an embodiment, the soil is made substantially impermeable to crude oil derivatives. In an embodiment the soil is made substantially impermeable to hydrocarbon fuels selected from the group consisting of diesel, M91 fuel, M95 fuel, M98 fuel, kerosene and crude oil.

Depending on the required depth of penetration, the permeability and the sieve curve of the soil, the amount of resin will have to be adjusted. It is desirable to perform a sieve curve analysis to assess the particle size distribution of the soil. This is done by allowing the material to pass through a series of sieves of progressively smaller mesh size and weighing the amount of material that is stopped by each sieve as a fraction of the whole mass, and thus establishing the particle size distribution. Methods for performing a sieve curve analysis and determining the permeability of the soil are well understood by the person skilled in the art.

In an embodiment, the polyurethane resin is applied in a single spray session (first spray session) to form a first layer. In another embodiment, the first layer of the polyurethane resin is allowed to set until hard, before being followed by a second spray session of the polyurethane resin to form a second layer. In another embodiment, the second layer of the polyurethane resin is allowed to set until hard, before being followed by one or more additional spray sessions, each forming additional layers, and each being allowed to set until hard before the subsequent session is applied.

In an embodiment from 4 kgs to 10 kgs resin are applied per m² of soil in a first spray. In an embodiment from 4.5 kgs to 7 kgs resin are applied per m² of soil. In an embodiment from 5 kgs to 5.5 kgs resin are applied per m² of soil.

In an embodiment, each layer is applied to one zone at a time. In an embodiment, each zone is prepared, and the layer is applied to that zone, before moving to the next zone. In an embodiment, each zone for the first spray session is up to about 200 m² in size. In an embodiment, each zone for the second and subsequent spray sessions is up to about 2000 m² in size.

In an embodiment, the method comprises positioning a truck with an intermediate bulk container (IBC) containing the polyurethane resin in proximity to the area to be treated. In an embodiment, a catalyst is added to the IBC if it is desired to accelerate the reaction. The amount of catalyst added depends on (a) porosity of the soil and (b) temperature of the resin and ambient temperature.

In an embodiment, the amount of catalyst added is from 0 to 2% w/w of the total amount of polyurethane resin in the IBC. In an embodiment, the IBC contains 1000 kgs of the polyurethane resin. In an embodiment, the amount of catalyst added is between 0 and 20 kg (inclusive thereof). The person skilled in the art will appreciate that the amount of catalyst added may need to be adjusted based on elements of the soil such as salt and acid (e.g., from acid rain).

The invention also relates to a method of forming or repairing a containment structure for containing a chemical compound or composition that may pollute groundwater. The method comprises the steps of constructing a containment structure with a base formed from soil and applying a polyurethane resin to the soil, wherein said polyurethane resin is adapted to incorporate soil particles into a matrix as it penetrates the soil to make the soil substantially impermeable to said chemical compound or composition.

The invention also relates a containment structure that surrounds a storage facility for storing a chemical compound or composition that may pollute groundwater, wherein the base of the containment structure is formed from soil and includes a layer comprising a matrix of polyurethane resin and soil particles that makes the soil substantially impermeable to said chemical compound or composition so that it will be contained within the containment structure if a leak or spill occurs.

In an embodiment the containment structure surrounds a tank farm.

In an embodiment the containment structure contains the leak or spill for a period of at least 7 days. In an embodiment, the containment structure contains the leak or spill for a period of at least 14 days.

In an embodiment, wherein the soil comprises a flat surface, for each zone, the method comprises:
a) positioning the truck near a front corner of a zone;
b) applying a layer of the polyurethane resin at an even rate per square meter of soil surface, starting in the corner of the zone farthest from the truck;
c) continuing to apply the polyurethane resin while moving in an even zig-zag pattern towards the front corner of the zone near where the truck is positioned, while ensuring that the polyurethane resin is evenly distributed and that no puddles form.

In an embodiment, if the layer being applied is the first layer, it is applied evenly at a rate of 5 kg polyurethane resin per m² of soil surface. In an embodiment, if the layer being applied is the first layer, the size of each zone is up to about 200 m². In an embodiment, the soil has normal permeability.

In an embodiment, the first layer is applied in multiple stages. In an embodiment, the first layer is applied in 2 stages, resulting in a total application amount of 5 kg polyurethane resin per m² soil surface, particularly when the soil has low permeability. In an embodiment, a first stage comprises applying the polyurethane resin at an even rate of 3 kg per m² soil surface, resulting in a first sublayer. In an embodiment a second or subsequent stage comprises applying the polyurethane resin at an even rate of 2 kg per m² soil surface, resulting in a second or subsequent sublayer. In an embodiment the second or subsequent stage comprises applying the polyurethane resin at an even rate of 1 kg per m² soil surface. In an embodiment, the second or subsequent sublayer is applied prior to the first sublayer hardening. In an embodiment, a third or subsequent stage comprises applying the polyurethane resin at an even rate of 0.5 kg per m².

In an embodiment, the third or subsequent sublayer is applied prior to the previous sublayer hardening.

In an embodiment, wherein a second, third, or subsequent layer is required, the method further comprises
a) allowing the previous layer to set until hard; and
b) applying another layer of the polyurethane resin, following steps (a)-(c).

In an embodiment, if the layer being applied is a second, third, or subsequent layer, the size of each zone is up to about 2000 m².

In an embodiment, the method further comprises:
a) between each spray session, determining if puddles of the polyurethane resin have formed;
b) checking if puddles are still present 5-10 minutes after spraying; and
c) if puddles are still present, dispersing each puddle to the surrounding area.

In an embodiment, the puddles are dispersed by blowing an air jet over the polyurethane resin. In an embodiment, the puddles are dispersed using a squeegee.

In an embodiment, wherein the surface of the soil comprises a sloped area, the method comprises applying a first layer of polyurethane resin comprising:
a) starting from a first side of a section, applying a first sublayer of the polyurethane resin to the higher end of the slope, at an even rate of 2 kg polyurethane resin per m² of soil surface;
b) starting from the first side of the section, applying a second sublayer of the polyurethane resin to the higher end of the slope, at an even rate of 1.5 kg polyurethane resin per m² of soil surface; and
c) starting from the first side of the section, applying a third sublayer of the polyurethane resin to the higher end of the slope, at an even rate of 1.5 kg polyurethane resin per m² of soil surface.

In an embodiment, wherein the surface of the soil comprises a sloped area, the method further comprises:
a) applying one or more additional sublayers, by starting at the first side of the section, and applying each sublayer of the polyurethane resin to the higher end of the slope, at an even rate of 1.5 kg polyurethane resin per m² of soil surface.

In an embodiment, wherein the surface of the soil comprises a sloped area, all sublayers of the first layer are applied to one section before moving to the next section. In an embodiment, wherein the surface of the soil comprises a sloped area, each section comprises up to about 20-30 meters of running slope. In an embodiment, wherein the surface of the soil comprises a sloped area, the method further comprises, after previous layer has hardened, applying a second or subsequent layer of polyurethane resin, comprising starting at the first side of the section and applying a new layer of the polyurethane resin to the higher end of the slope, at an even rate of 0.5 kg polyurethane resin per m² of soil surface.

In an embodiment, wherein the soil surface contains a pipe penetration, the method further comprises, after the first layer of polyurethane resin has been applied, applying an extra amount of 2 kg polyurethane resin per m² soil surface, in the area surrounding the pipe penetration. In an embodiment, wherein the soil surface contains a pipe penetration, prior to the application of the polyurethane resin, the soil surrounding the pipe penetration is first shaped into the required profile. In an embodiment, wherein the soil surface contains a pipe penetration, the method further comprises, after the second or subsequent layer of polyurethane resin has been applied, applying an extra amount of 0.5 kg polyurethane resin per m² in the area surrounding the pipe penetration. In an embodiment, wherein the soil surface contains a pipe penetration, the method further comprises:
a) prior to any application of the polyurethane resin, wrapping the pipe in a plastic sheet to protect it from exposure to the polyurethane resin; and
b) after all layers of the polyurethane resin have hardened, removing the plastic sheet.

In an embodiment, wherein the soil touches the base of a tank or other object, the method further comprises, after the first layer of polyurethane resin has been applied, applying an extra amount of 2 kg polyurethane resin per m² soil surface in the area surrounding the base of the tank or other object. In an embodiment, wherein the soil touches the base of a tank or other object, prior to the application of the polyurethane resin, the soil surrounding the tank or other object is first shaped into the required profile. In an embodiment, wherein the soil touches the base of a tank or other object, the method further comprises, after the second or subsequent layer of polyurethane resin has been applied, applying an extra amount of 0.5 kg polyurethane resin per m² in the area surrounding the base of the tank or other object. The other object can be any physical static structure, such as a light pole, a shed, a building, a fence, stairs, etc.

In an embodiment, the method further comprises visually inspecting the treated zones for areas where the soil may still be exposed; and applying additional polyurethane resin to those areas.

In an embodiment the repair area overlaps areas that do not require repair. In an embodiment there is overspray of about 50 cms onto the areas that do not require repair.

In a further aspect the invention relates to a method of repairing or replacing a containment structure in a repair area, comprising:
a) breaking up the existing matrix in the repair area;
b) replacing the broken-up matrix of the repair area with soil particles; and
c) applying a polyurethane resin to the soil particles in the repair area, wherein said polyurethane resin is adapted to incorporate soil particles into a matrix as it penetrates the soil to make the soil in the repair area substantially impermeable to a chemical compound or composition that is capable of polluting ground water.

In an embodiment, the invention relates to a method of repairing or replacing the structural matrix in an area. In an embodiment, the method of repairing or replacing the structural matrix consists of
a) breaking up the existing structural matrix in the repair area;
b) replacing the top 10 cm of the repair area with normal grade builders' sand or similar; and
c) installing the tanking system by any of the methods previously described.

In an embodiment, the method of repairing or replacing the structural matrix further comprises, prior to (b):
(i) carrying out any required excavation and/or works; and
(ii) filling in the excavated area with an appropriate backfilling material, such as normal grade builders' sand.

In an embodiment, the required excavation and works can be to repair underground pipes, add extra piping and/or to access utilities below the surface.

In an embodiment, the method of repairing or replacing the structural matrix further comprises, prior to (c), compacting the surface of the repair area. In an embodiment, the surface is compacted by rolling a cylinder over it.

In an embodiment, the method of repairing or replacing the structural matrix further comprises:
a) checking if puddling occurs, and, if puddling occurs, directing the puddled resin towards the repair area.

### MODES FOR CARRYING OUT THE INVENTION

### Example 1: General Application

Application of a one component polyurethane (SandSeal MS® supplied by NeoFerma) will result in a hardened, strengthened and substantially impermeable layer when applied to a variety of substrates configured in different ways to facilitate tanking of a tank farm.

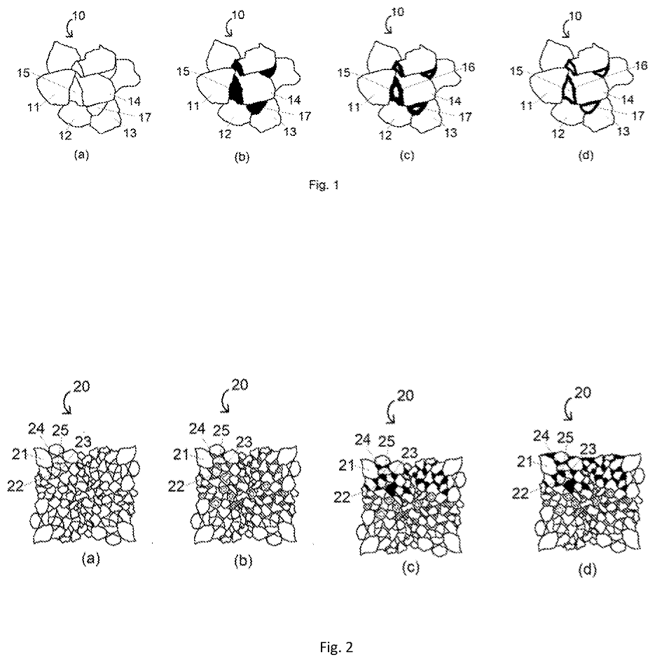

FIG. 1 illustrates the concept. FIG. 1 (a) shows a group of soil particles 10 as they might exist before treatment, without filling. It will be noted that particles 11, 12 and 14 touch at points to form void 15, and similar voids such as void 17 formed by particles 12, 13 and 14 can be seen elsewhere. FIG. 1(b) shows the same group of particles 10 with the voids, including voids 15 and 17 now completely filled with polyurethane resin as might be expected, for example, after three applications of polyurethane resin. FIG. 1(c) shows a medium degree of filling of the voids, such as after two applications of polyurethane resin. As can be seen for void 15, the voids are now much smaller in size and a layer 16 of polyurethane resin is present on particles 11, 12 and 14. Finally, FIG. 1(d) shows a lower degree of filling, such as after a single application of polyurethane resin. Void 15 is now somewhat smaller in size and has a thin layer 16 of polyurethane resin on particles 11, 12 and 14.

FIG. 2(a) shows a sand substrate 20 comprising a plurality of particles such as particles 21, 22, 23 and 24 prior to treatment. FIG. 2(b) shows the sand substrate 20 after a first layer of polyurethane resin has been applied. Voids such as void 25 created by particles 21, 22, 23 and 24 are partially filled. FIGS. 2(c) and 2(d) show further filling of voids such as void 25 with further applications of polyurethane resin. It will be noted that a substantially impermeable layer is formed where all voids are filled. There may be penetration of the polyurethane resin to a level that is deeper than this, and then there will be partial filling of some deeper voids, but these voids do not have to be filled completely.

It will be appreciated that the stepwise application of polyurethane resin as shown in FIGS. 1 and 2 is not necessary, and the result shown in FIGS. 1(b) and 2(d) can be achieved, for example, with one, two or more application/s of polyurethane resin under appropriate conditions. Nevertheless, application in three separate treatments is preferred and such a process will now be described with reference to FIGS. 2 to 8.

### Soil Preparation

The top surface of an area of sandy soil was shaped to the desired shape and flatness for tanking a tank farm. Pieces of debris and larger boulders were removed. The areas around pipe penetrations and tanks were shaped to the required form. The sand surface was flattened so puddles would not be formed during spraying of the SandSeal MS® resin. The sand surface was compacted by rolling a cylinder over it.

The surface was compacted by rolling a cylinder over it. The cylinder weighted between 20 and 50 kg per meter of cylinder roll.

The soil by was wet by spraying a clean water mist over the soil about 30 minutes before spraying the first layer of SandSeal MS®.

The area of soil was divided into zones and prepared zone by zone. A zone is the area that can be treated in one session. For the first layer that is about 200 m². For second or eventual 3^{rd} coats, an area of 2000 m² can be done in one session. The spray areas overlap by about 50 cm when a new zone is treated adjacent to a zone that has already been treated.

### Preparing the Resin

A truck carrying an intermediate bulk container (IBC) with SandSeal MS® resin and a pump was positioned close to the area to be treated, making sure that the hoses were long enough and the truck positions correctly so the whole area could be reached with the sprayers.

Different scenarios on site will present themselves and application steps are described for several of these.

### Example 2: Flat Surface Normal Porosity Soil

### First Layer

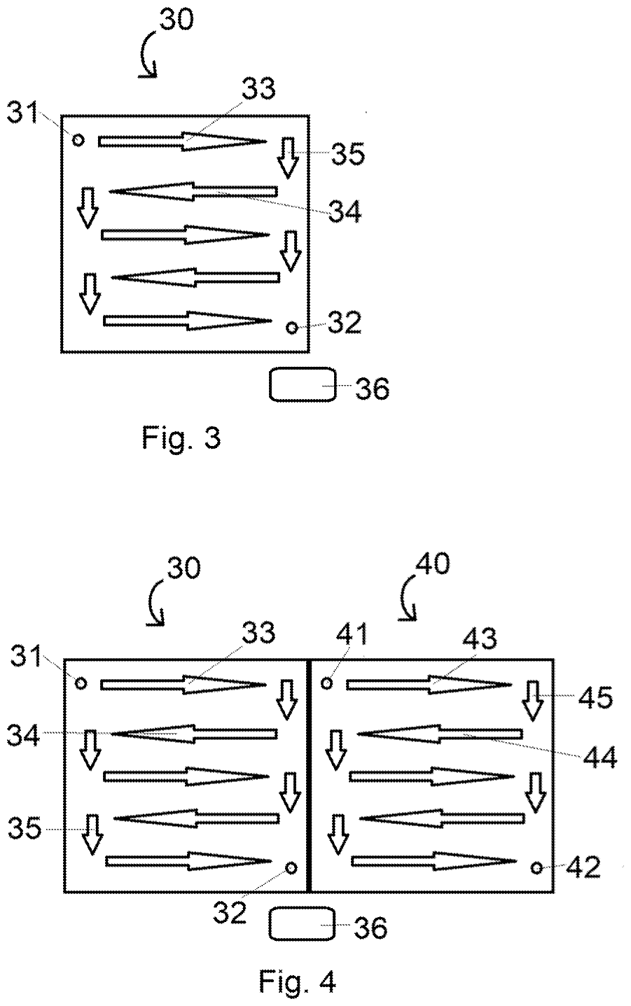

Spraying a first sublayer involved evenly spraying of 3 kg of SandSeal MS® resin per square meter to a first zone 30 in accordance with the scheme shown in FIG. 3. Spraying started at the starting point in the far corner 31 of the zone 30. The process involved evenly spraying the resin while moving first in the direction of arrow 33 across the zone and then in the direction of arrow 34, while generally moving in the directions of arrow 35, in order to create a zigzag pattern. Spraying was terminated once the end point 32 adjacent the installation truck 36 was reached. Then, before the resin from the first sublayer hardened (i.e., while the first sublayer was still liquid), a second lot of resin was applied in the same manner, at an even rate of 2 kg of SandSeal MS resin per square meter. The next zone 40 was prepared, and the same sequence repeated (FIG. 4). In this case spraying started at the starting point in the far corner 41 of the zone 40. The process involved evenly spraying the resin while moving first in the direction of arrow 43 across the zone and then in the direction of arrow 44, while generally moving in the directions of arrow 45, in order to create a zigzag pattern. Spraying was terminated once the end point 42. A second sublayer was applied in the same was as for zone 30.

It is normal that the resin does not penetrate immediately fully into the soil and it was allowed some time to sink in. However, if resin remained on the surface in a puddle 5-10 minutes after spraying, the excess resin was dispersed to the surrounding area, preferably by blowing an air jet over the resin (although a squeegee or other means of dispersion can also be used, as long as the soil surface is not disturbed).

### Second Layer

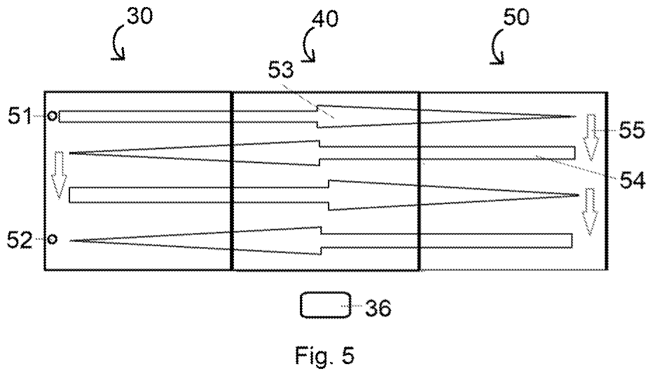

After the first layer had hardened, the second layer was applied. The same technique was used for the second layer, but only 1 kg of SandSeal MS® resin per m² was applied. The zones to coat can be larger than for the first spray coat. As shown in FIG. 5, the second layer was applied across zone 30, and 50 as well as another zone 50 of the same size that had been treated in the same way. Application across the zones commenced at start point in the direction of arrow 53, and thereafter in the direction of our 54, while moving generally in the direction of arrow 55. Hence application was in a zigzag pattern moving from start point 51 to end point 52 across the entire three zones.

If resin remained on the surface in a puddle 5-10 minutes after spraying, the excess resin was dispersed to the surrounding area. Since the substrate was already hard, either a squeegee or an air-blower was used.

### Example 3: Flat Surface Low Porosity/Slow Penetration Soil

### First Layer

If the soil substrate has a slow penetration rate for the SandSeal MS® resin, the first layer might have to be applied in 2 stages.

For slow penetration soil substrates, the SandSeal MS® was applied as per Example 2.

If resin remained on the surface in a puddle 5-10 minutes after spraying the second sublayer, the excess resin was then dispersed to the surrounding area by using an air-blower or squeegee.

### Second and Third Layers

After the first layer (applied in 2 runs) had hardened (not fully cured), the second layer was applied.

The same technique was used for the second layer, but only 1 kg of SandSeal MS® resin per m² was applied. After the second layer had hardened (not fully cured), the third layer was applied.

The same technique was used for the third layer, but only 0.5 kg of SandSeal MS® resin per m² was applied. The zones to coat can be larger for the second and third layers than for the first layer (FIG. 5).

If resin remained on the surface in a puddle 5-10 minutes after spraying, excess resin was dispersed to the surrounding area. Since the substrate was already hard, either a squeegee or an air blower could be used.

### Example 4: Sloped Areas

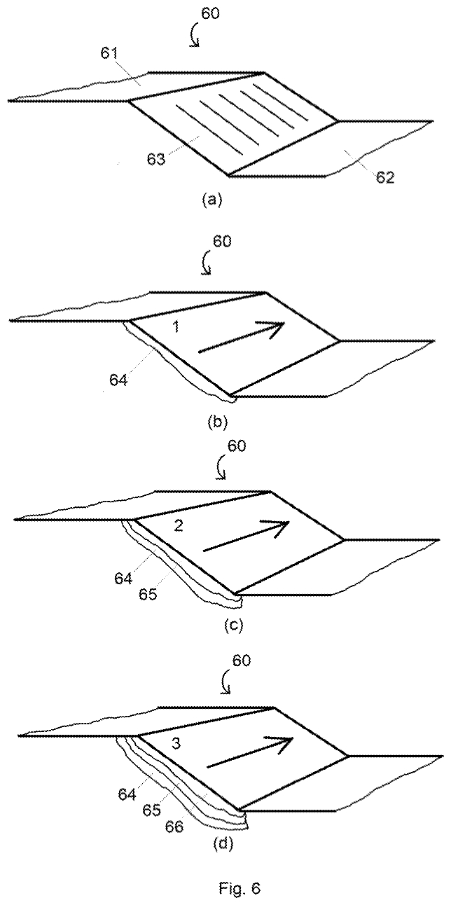

In areas where the soil substrate is at an angle, the resin does not pool as it does on a flat surface. Instead, if excess resin is applied has the tendency to run off towards the lower part of the slope where it puddles. This is shown in FIG. 6 for sloped area 60. To make sure the resin penetrates deep enough in the sloped area, the application of the SandSeal MS® Tanking system needs to be adjusted. This is achieved by making the first application in three stages.

### First Coat

About 2 kg per m² of SandSeal MS® resin was sprayed on the surface of the sloped area 60. The resin was applied to about 20-30 running meters of slope before returning to the start point and applying 1.5 kg per m² to the same section of slope while the first spray was still liquid to form treated sublayer 64 as seen in FIG. 6(b).

More resin was sprayed on the higher end of the slope before the sublayer 64 had cured, allowing the resin to run down and sink into the lower parts of the sloped substrate to form sublayer 65. The first sublayer 64 has penetrated the soil to an extent, hence sublayer 65 forms closer to the surface as seen in FIG. 6(c).

After the second spray, beginning from the start point a final coat of 1.5 kg/m² was applied to the same section of slope, again concentrating more resin on the higher part of the slope. This forms sublayer 66. The first sublayer 64 and second sublayer 65 have penetrated the soil to an extent, hence sublayer 66 forms closer to the surface than either of sublayers 64 or 65 as seen in FIG. 6(d).

Depending on the actual situation, the number or runs in the first layer, the resin amounts per run and the surface area per zone can be adjusted.

### Second and Third Coat

After the first layer had sufficiently cured (hardened, not fully set), a second coat of 1 kg/m² of SandSeal MS® resin was applied. More resin was sprayed over the higher level of the slope, allowing the runoff of the resin to cover the whole slope area. The resin flows through the area covered by sublayers 64, 65, 66 and further fills the voids between soil particles as shown in FIGS. 1 and 2.

After the second layer had sufficiently cured (hardened, not fully set), a third coat of 0.5 kg/m² of SandSeal MS® resin was applied. More resin was sprayed over the higher level of the slope, allowing the runoff of the resin to cover the whole slope area. The resin flows through the area covered by sublayers 64, 65, 66 and further fills the voids between soil particles as shown in FIGS. 1 and 2 to the point where some voids are completely filled to form a substantially impermeable layer.

### Example 5: Pipe Penetrations

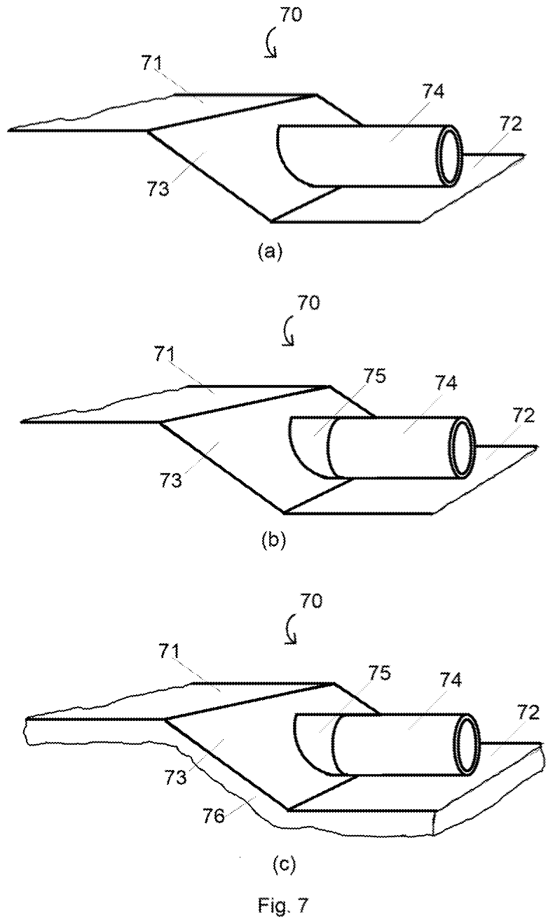

Pipe penetrations in the soil do not cause any specific problem. A 3-coat spray system will set around the pipe-soil interface and make the area substantially impermeable. As an extra protection, an extra coating can be applied in the area around the pipe penetration, as exemplified below as illustrated in FIG. 7.

A slope 73 connects upper flat surface 71 and lower flat surface 72. A pipe 74 penetrates slope 73 and was protected with a piece of plastic sheet 75 prior to installation of the SandSeal MS® Tanking system. Following installation, the plastic sheet can be removed.

During the application of the first sublayer, an extra amount of 2 kg/m² was applied to the area around the pipe penetration (total of 7 kg/m²) using the method described in Example 4. During the application of the second sublayer, an extra amount of 0.5 kg/m² was applied to the area around the pipe penetration. Finally, a third coat of 0.5 kg/m² was applied to the area around the pipe penetration.

### Example 6: Around the Tanks

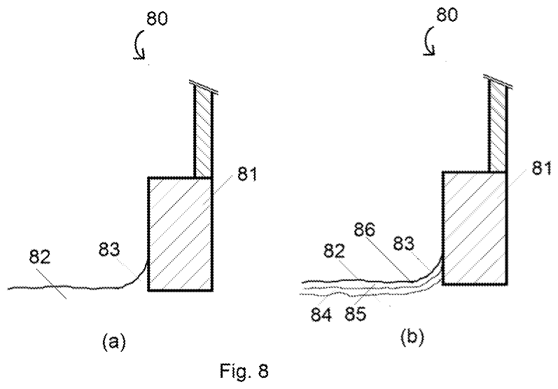

FIG. 8 illustrates application around a tank 81 such as a tank in a tank farm 81. Where the soil touched the base of the tank 81, the soil substrate was shaped to form mound 83.

Resin was applied to mound 83 and an area 82 adjacent its base as described in Example 4. During the application of the first sublayer, an extra amount of 2 kg/m² was applied to the area 82 around the base of the tank (total of 7 kg/m²). During the application of the second sublayer, an extra amount of 0.5 kg/m² was applied to the area around base of the tank. Treated sublayers 84, 85 and 86 formed in the process are shown in FIG. 8(b).

### Example 7: Finishing

After installing the SandSeal MS® Tanking system, a visual inspection of the treated zones was conducted. If there were spots where the soil seemed to be open, some extra SandSeal MS® resin was applied over these areas.

After finishing for the day, remove all resin was removed from the lines of the pump back into the IBC and the pump and lines were rinsed with an appropriate cleaning agent (solvent such as methyl ethyl ketone (MEK) or similar).

When the pump was not in use for a longer period, the pump's mechanism was filled with vegetable oil.

For overnight or weekend storage the cleaning agent can stay in the pump and lines.

### Example 8: Penetration and Permeability Testing

Two samples of topsoil blend were lightly compacted within a rectangular container. The soil had a surface area of 1.5 m² and an oval-shaped depression was formed therein. The soil contained between 1.2 and 1.4% moisture content depending on which part of the sample was tested. No water was applied before coating. Three coats of polyurethane resin (SandSeal MS®) were applied. There was no addition of catalyst. In both tests 6.16 litres (7.2 kg) of polyurethane resin were applied in the first coat, 620 ml (0.72 kg) in the second coat and 310 ml (0.36 kg) in the third. The first coat was applied at an ambient temperature of 19° C., the second coat two hours later at an ambient temperature of 24° C. and the third coat 4.5 hours later at an ambient temperature of 24° C. The temperature of the resin product was 24° C. The second sample had its first coat applied when the ambient temperature was 19° C., the second coat when it was 24° C. and the third coat when it was 24° C. In both tests a watering can was used to apply the first 2 litres of the first coat while the remaining 4.16 litres of the first coat was applied using a garden spray unit. The second and third coats were applied using the garden spray unit in the same manner. Resin was observed to slightly pool in the centre.

In sample 1, water was loaded into the depression after 14 hours. The sample held water for five days. The water level dropped 15 millimetres, but it was confirmed that the water loss was purely due to evaporation as there was the same drop in level in a reference bucket. Water was emptied out of the test sample and 20 litres of unleaded petroleum fuel was added to 125 millimetres deep. After two days there had been a drop in level to 105 mm, which was consistent with the level drop in a test bucket. In sample 2 there was no leakage of water observed over 20 days.

### Example 9: Penetration and Permeability Testing on Site

A site with soil comprising river sand with some coarse aggregate was selected for testing. Three sections of the site, each 3.2 m² in size, were tested. The moisture content of the soil over the first site was 1.7% while the moisture content of the second site was around 1% and the third site was about 1.5%. Three coats of polyurethane resin (SandSeal MS®) were applied. The first coat consisted of 2 kg resin was applied by watering can then 3 kg was applied by garden sprayer. The next day 0.5 kg of resin was applied by garden sprayer and brush followed a by a third coat of 0.25 kg resin applied by garden sprayer and brush. There was no addition of catalyst. The ambient temperature was 16° C. and the temperature of the resin was 22° ° C. to 24° C. The higher moisture content of the first sample compared to the second gave a smoother surface finish.

The first section was loaded with water seven days after treatment and a reference reservoir was loaded with water to the same depth. The first section was found to be impermeable to water over a period of two weeks since water drop in the site was the same as in the reference reservoir. The second section was loaded with fuel and a reference reservoir was loaded to the same depth. After a period of two weeks there was no difference in the level of fuel at the test section compared to the reference reservoir, and therefore it was concluded that the test section is impermeable to diesel fuel over that period. The third section was loaded with unleaded M91 fuel and a reference reservoir was loaded to the same depth. After a period of two weeks there was no difference in the level of M91 fuel at the test section compared to the reference reservoir, and therefore it was concluded that the test section is impermeable to fuel over that period.

The penetration depth was measured to be, on average, 35 to 40 mm for all tests in Examples 8 and 9.

Throughout the specification the aim has been to describe preferred embodiments of the invention without limiting the invention to any one embodiment or specific collection of features. It will be appreciated by those of skill in the art that, in light of the present disclosure, various modifications and changes can be made in the particular embodiments exemplified without departing from the scope of the invention.

1. A method of containing a chemical compound or composition that may pollute groundwater within a containment structure that has a base formed from soil, comprising applying a polyurethane resin to the soil, wherein said polyurethane resin is adapted to incorporate soil particles into a matrix as it penetrates the soil to make the soil substantially impermeable to said chemical compound or composition.

2. A method of forming or repairing a containment structure for containing a chemical compound or composition that may pollute groundwater, comprising the steps of:
(a) constructing a containment structure with a base formed from soil:
(b) applying a polyurethane resin to the soil, wherein said polyurethane resin is adapted to incorporate soil particles into a matrix as it penetrates the soil to make the soil substantially impermeable to said chemical compound or composition.

3. A method according to claim 1, wherein the polyurethane resin creates a substantially impermeable layer in the soil.

4. A method according to claim 1, wherein the substantially impermeable layer is from to about 2 to 12 cm deep.

5. A method according to claim 1, wherein the substantially impermeable layer is from to about 3 to 10 cm deep.

6. A method according to claim 1, wherein the substantially impermeable layer is from to about 4 to 7 cm deep.

7. A method according to claim 1, wherein the polyurethane resin has low viscosity to allow it to penetrate the soil.

8. A method according to claim 1, wherein the polyurethane resin comprises a single-component water-activated polyurethane resin.

9. A method according to claim 8, wherein cross-linking occurs subsequently to the application of the single-component water-activated polyurethane resin to the soil.

10. A method according to claim 1, wherein a catalyst for accelerating the reaction of isocyanate groups in the polyurethane resin with water is introduced just prior to application of the single-component water-activated polyurethane resin to the soil.

11. A method according to claim 1, wherein the polyurethane resin is formulated as a composition that further comprises a carrier.

12. A method according to claim 11, wherein the carrier is a polar solvent such as an ester or ketone.

13. A method according to claim 1, wherein the polyurethane resin is sprayed or poured onto the soil.

14. A method according to claim 1, wherein the polyurethane is applied in multiple coats to progressively build the substantially impermeable layer.

15. A method according to claim 1, wherein the soil is made substantially impermeable to hydrocarbons or hydrocarbon-based compositions.

16. A method according to claim 15, wherein the soil is made substantially impermeable to a fuel selected from the group consisting of diesel, M91 fuel, M95 fuel, M98 fuel, kerosene, and crude oil.

17. A containment structure that surrounds a storage facility for storing a chemical compound or composition that may pollute groundwater, wherein the base of the containment structure is formed from soil and includes a layer comprising a matrix of polyurethane resin and soil particles that makes the soil substantially impermeable to said chemical compound or composition so that it will be contained within the containment structure if a leak or spill occurs.

18. A method according to claim 17, wherein the containment structure surrounds a tank farm.

19. A method according to claim 17, wherein the containment structure contains the leak or spill for a period of at least 7 days.

20. A method according to claim 17, wherein the containment structure contains the leak or spill for a period of at least 14 days.

21. A method of repairing or replacing a containment structure according to claim 17 in a repair area, comprising:
(a) breaking up the existing matrix in the repair area;
(b) replacing the broken-up matrix of the repair area with soil particles; and
(c) applying a polyurethane resin to the soil particles in the repair area, wherein said polyurethane resin is adapted to incorporate soil particles into a matrix as it penetrates the soil to make the soil in the repair area substantially impermeable to a chemical compound or composition that is capable of polluting ground water.

22. The method of claim 21, wherein the soil particles that replace the broken-up matrix of the repair area are from sand.
